(19) United States
(12) Patent Application Publication
(10) Pub. No.: US 2012/0145764 A1
(43) Pub. Date: Jun. 14, 2012

(54) INSTALLATION DEVICE

(75) Inventors: Joseph Fiorini, Hopewell Jct, NY (US); Edward J. Kilcheski, Fresh Meadows, NY (US)

(73) Assignee: Consolidated Edison Company

(21) Appl. No.: 12/964,017

(22) Filed: Dec. 9, 2010

(51) Int. Cl. B25C 7/00; B23P 11/00

(52) U.S. Cl. 227/147; 29/432

(57) ABSTRACT

An installation device for installing a fastener into a solid object, such as a roadway, is described. The installation device can be made of a sleeve and a rod with a power hammer connector on a proximal portion of the rod. The sleeve can have an inner bore having an inner volume configured to receive a fastener. The rod can be selectively inserted within the inner bore of the sleeve. The distal end of the rod can have a substantially flat surface. The installation device enhances containment of the spike during installation, which can significantly reduce damage and injuries resulting from fly-away fasteners. Other embodiments are also described.

### FIELD

This application relates generally to an installation device and system that supports and drives a fastener, such as a spike, into a solid object, such as a roadway. More specifically, this application relates to an installation device that surrounds and guides a fastener while it is driven into the surface of a solid object.

### BACKGROUND

Spikes, stakes, nails, large staples, and other such fasteners can be used to secure together large, objects, such as metal, wood, asphalt, etc. For instance, spikes are commonly driven into railroad ties to secure rails and tie plates to the tie. Additionally, spikes are commonly driven into asphalt roads to secure steel traffic plates in place on a roadway surface. Traditionally, spikes have been driven into target objects using a sledge hammer that is manually hefted by a user.

### SUMMARY

This application describes an installation device for installing a fastener into a solid object, such as a roadway. Generally, the installation device can be made of a sleeve and a rod with a power hammer connector on a proximal portion of the rod. The sleeve can have an inner bore having an inner volume configured to receive a fastener. The rod can be selectively inserted within the inner bore of the sleeve. The distal end of the rod can have a substantially flat surface. The distal end of the rod can be magnetized to attract and hold a fastener thereon. The installation device enhances containment of the spike during installation, which can significantly reduce damage and injuries resulting from fly-away fasteners.

### BRIEF DESCRIPTION OF THE DRAWINGS

The following description can be better understood in light of the Figures, in which:

FIG. 1A depicts some embodiments of a impact device coupled to a installation device prior to the fastener being driven into the ground;

FIG. 1B depicts some embodiments of the impact device and installation device of FIG. 1A where the fastener is driven into the ground;

FIG. 2 depicts a perspective view of some embodiments of a installation device;

FIG. 3 depicts a cross-sectional view of a installation device according to some embodiments;

FIG. 4 depicts a cross-sectional view of some embodiments of the installation device of FIG. 3 prior to the fastener being driven into the ground;

FIG. 5 depicts a cross-sectional view of some embodiments of the installation device of FIG. 3 after to the fastener is driven into the ground;

FIG. 6 depicts an exploded, perspective view of a installation device according to some embodiments;

FIG. 7 depicts a cross-sectional view of a sleeve of a installation device according to some embodiments;

FIG. 8A depicts a partial cross-sectional view of a sleeve and a rod according to some embodiments;

FIG. 8B depicts another cross-sectional view of a sleeve and a rod according to some embodiments;

FIG. 8C depicts a cross-sectional view of the sleeve of FIG. 8B and a fastener according to some embodiments;

FIG. 9 depicts a cross-sectional view of a non-circular sleeve and a fastener according to some embodiments; and

FIG. 10 depicts another partial cross-sectional view of a sleeve and a rod according to some embodiments.

The Figures illustrate specific aspects of the installation device comprising an installation device and methods for installing a fastener with the installation device. Together with the following description, the Figures demonstrate and explain the principles of the structure and methods of this device. The same reference numerals in different drawings represent the same element, and thus their descriptions will not be repeated.

### DETAILED DESCRIPTION

The following description supplies specific details in order to provide a detailed understanding of the Figures. Nevertheless, the skilled artisan would understand the installation devices and methods for using these devices could be implemented and used without employing these specific details. Indeed, the installation devices and associated methods can be placed into practice by modifying the illustrated devices and methods and can be used in conjunction with any other apparatus and techniques conventionally used in the industry. For example, while description refers to installation devices for driving spikes into a roadway, it could be modified and used for fasteners other than spikes, such as spikes, stakes, nails, large staples, magnetic spikes, steel rebar, and solid objects other than roadways, such as concrete, stone, dirt, clay, wood, metal, etc.

Some embodiments of the installation devices and methods for using such devices are described herein and illustrated in the Figures. In this Figures, the term proximal refers to a part of the device or component near the user while the term distal refers to a part of the device or component away from the user. The installation devices contain an impact device (such as a power hammer) that drives a fastener (such as a spike) into a solid object (such as blacktop or asphalt surface). In some embodiments, the fastener can be used to attach an attachment member (such as a metal plate) to the solid object. Other representative attachment members include railroad ties, façade supports, and the like.

The installation device can work with any suitable impact device known in the art, such as power hammers, pistons, or impact guns. The impact devices repeatedly produce an impact force on the fastener, thereby driving it into the solid object. As well, the installation device can also stabilize the fastener during this process. The installation device can be used to drive the selected fastener into any solid object. Representative solid objects include roadways, wood, concrete, metal, rock, etc. The installation device can be utilized with any suitable fastener known in the art. Examples of suitable fasteners include spikes, stakes, nails, large staples, magnetic spikes, rods, or rebar.

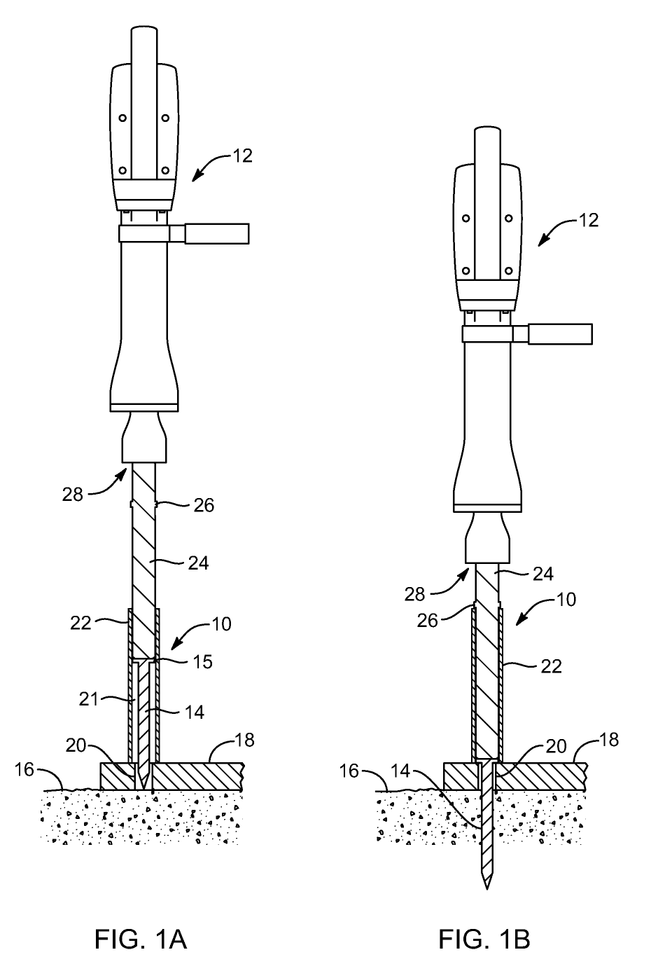

In some embodiments, the impact device comprises a power hammer and the fastener includes a spike. These embodiments are illustrated in FIGS. 1A and 1B, where a power hammer 12 drive a spike 14 through a metal plate 18 into a surface 16 of the solid object, such as a blacktop (or asphalt) surface. Metal plates, such as the plate 18 of FIGS. 1A-1B, may cover portions of a road surface that is under construction. Traditionally spikes, such as that depicted in FIGS. 1A-1B, were manually driven by a user hefting a sledge hammer. The dangers associated with this technique can be overcome using the installation device 10 described herein.

As shown in FIGS. 1A and 1B, the installation device 10 can prevent injuries caused by flying spikes by surrounding and containing the spike 14 within a retractable sleeve 22. This sleeve 22 supports the spike in an upright position while preventing it from accidentally flying away in any direction. Since the sleeve 22 is retractably disposed around a rod 24, it retracts automatically as a rod 24 drives the spike 14 downward.

The installation device 10 can prevent injuries by enabling the use of power hammers 12. Power hammers 12, such as a pneumatic drill/hammer (or jackhammer) or impact gun, can be powered by electricity, compressed air, hydraulics, etc. and can reduce the manual force required to install the spike 14. Using the power hammers avoids the used manual sledge hammers, reducing the number of soft tissue injuries that might otherwise occur during spike installation.

In use, as illustrated in FIG. 1A, a rod 24 of the installation device 10 is coupled to a power hammer 12. The sleeve 22 is extended away from the power hammer 12 and the spike 14 is inserted into the sleeve. The power hammer 12 then reciprocates the rod 24 upward and downward to drive the stake 14 into the surface 16. As the stake 16 is driven into the surface 16, the sleeve 16 remains in contact with the surface, preventing the spike 14 from moving laterally or flying away. As shown in FIG. 1B, as the spike 14 is driven into the surface 16, the rod 24 moves deeper into the sleeve 22, causing the self-retracting action of the sleeve 22 as the sleeve moves higher relative to the rod.

Referring now to the specific parts illustrated in FIGS. 1A-1B, the installation device contains both a sleeve 22 and a rod 24. The sleeve can have any configuration that can receive the fastener. Thus, in some embodiments, the sleeve can be configured with an inner bore having an inner volume configured to receive a spike. The sleeve of the installation device enhances containment of the spike during installation, which can significantly reduce damage and injuries resulting from fly-away spikes.

The rod 24 can be inserted within the inner bore of the sleeve. The distal end of the rod can have a substantially flat surface. The rod 24 is an elongated body member, such as a bar. In some embodiments, the rod 24 is a solid rod, such as a solid metal rod. The rod 24 can be manufactures of a variety of materials configured to withstand repeated pounding. Representative materials include steel, iron, etc.

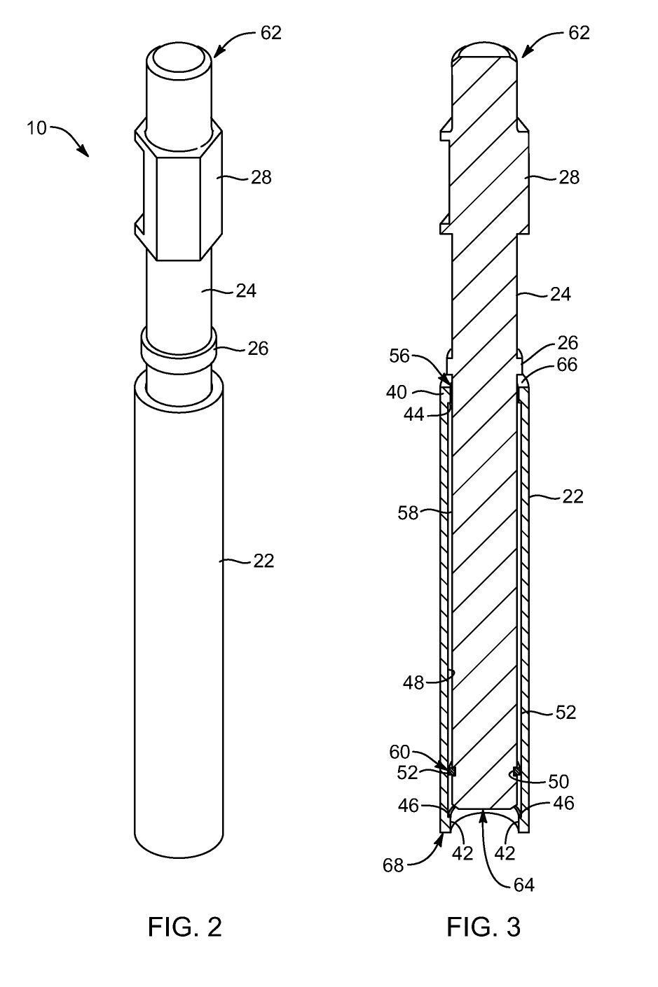

The proximal end portion of the rod 24 can connects the rod to the impact device. In some embodiments, the rod 24 can be coupled to a power hammer 12 via connector 28 that is disposed on a proximal portion of the rod, such as the proximal 0% -15% of the rod's length. The connector 28 is a feature or component of the rod used to connect to an impact device. The impact device connector 28 can have a variety of shapes, sizes, and configurations, based on the shape and size of the rod and the type of impact device 12 used. This impact device connector 28 can be as simple as a flat surface on a cylindrically-shaped rod 24, or a hole (not shown) through the rod 24. Alternatively, in some embodiments, this impact device connector 28 is a set of shapes and surfaces that mate with the power hammer 12, such as the impact device connector 28 depicted in FIG. 2. In some embodiments, the impact device connector can comprises any suitable power hammer connector known in the art.

The rod 24 extends distally from the power hammer connector 28 for a length that is greater than or substantially equal to the length of a spike. In some embodiments, the rod's length is between about two and about forty inches. In other embodiments, the rod's length is less than about two inches or greater than about forty inches. In some embodiments, the rod's length is between about six and about twenty-four inches. In some embodiments, the rod's length is between about six and about eighteen inches.

The distal end of the rod 24 contacts the head 15 of the spike 14, transferring the downward force of the power hammer to the spike, driving it downward. Accordingly, the surface of the distal end of the rod 24 may have a shape that most effectively transfers this force. For example, in some embodiments, the distal rod surface is a single drive surface, having no edges, corners, or other junctures on the distal face of the rod. In some embodiments, this surface is substantially flat having only minor curvature. The substantially flat surface may have minor deviations from a perfect mathematical plane. For example, in some embodiments, it may be advantageous to provide some curvature on the distal end of the rod. For instance, in some embodiments, the substantially flat distal surface may includes a concave shape that mates with the top surface of the spike's head 15. Such a concave surface may be useful in maintaining the head of a spike in a proper placement relative to the rod and the inner bore.

In some embodiments, the distal end of the rod 24 is magnetized. This magnetizated end can attract a spike 14 and assist to retain the spike within the sleeve prior to the spike installment. Additionally, in some embodiments, the spike or other fastener is magnetized. In some embodiments both the distal end of the rod 24 and the fastener are magnetized.

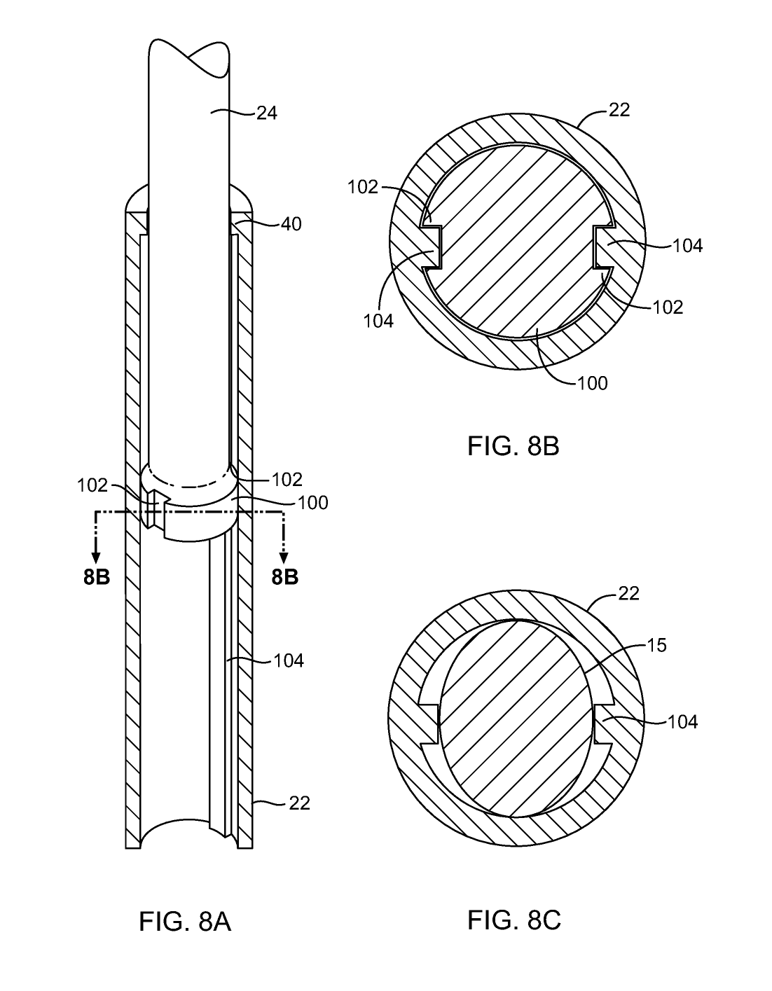

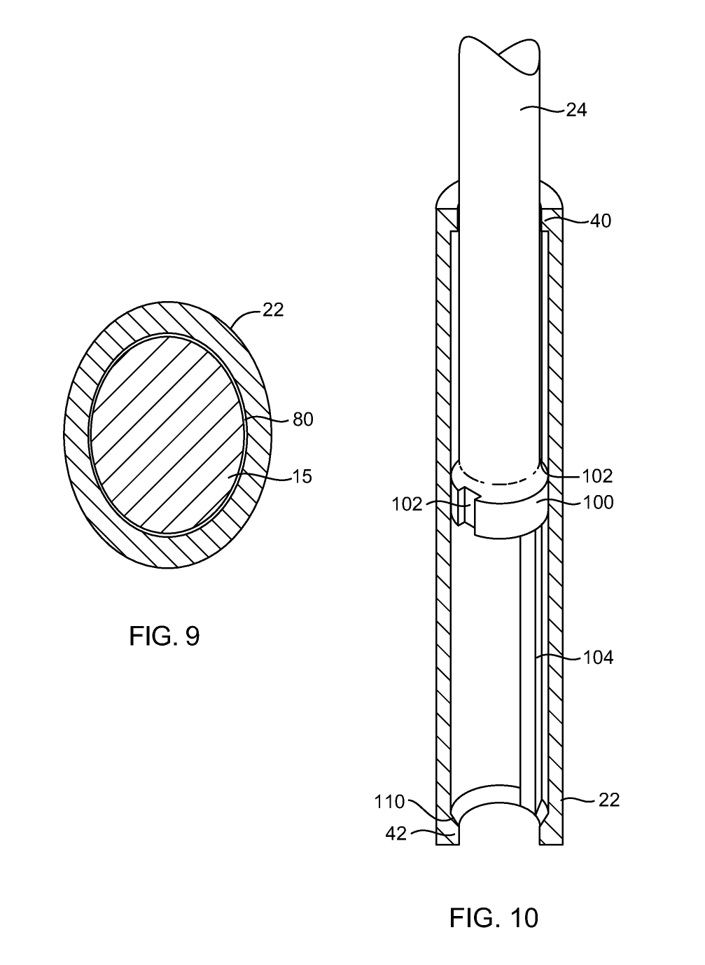

In some embodiments, the sleeve 22 can be a hollow body having two ends, a distal end and a proximal end, and an inner bore 21 extending between these two ends. The sleeve may be, but is not necessarily, cylindrical. Rather, the sleeve, the rod, and the inner bore may be manufactured in a variety of shapes and sizes depending on the intended use of the installation device. Thus, in some embodiments, the sleeve, rod, and/or the inner bore have circular, elliptical, oval, square, or rectangular cross sections. For example, FIG. 8B illustrates a sleeve 22, an inner bore, and a rod 100 having substantially circular cross sections, while FIG. 9 illustrates a sleeve 22 and inner bore having an oval-shaped cross section.

The sleeve 22 can be retractably disposed around a portion of the rod 24. Accordingly, the sleeve, the inner bore, and the rod can a variety of sizes and dimensions. In some embodiments, the rod and inner bore have constant cross sectional areas along their lengths. In these embodiments, the cross sectional area of the inner is approximately equal to or great than cross sectional area of the rod 24. In other embodiments, the cross sectional areas of the rod and/or the inner bore can vary along their lengths. Similarly, the sleeve, the inner bore, and the rod can a variety of sizes and dimensions.

Generally, the inner bore can be shaped to house a spike. Accordingly, in some embodiments, in some embodiments, the inner bore has a length between two and forty inches. In other embodiments, the inner bore's length is less than about two inches or greater than about forty inches. In some embodiments, the inner bore's length is between about six and about twenty-four inches. In some embodiments, the inner bore's length is between about six and about eighteen inches. Additionally the inner bore may have a cross sectional area between about one and about thirty square inches. In other embodiments, the inner bore's cross sectional area is less than about one square inches or greater than about thirty square inches. In some embodiments, the inner bore's cross sectional area is between about three and about ten square inches. In some embodiments, the inner bore's cross sectional area is between about four and about eight square inches.

The sleeve 22 can disposed around a distal portion of the rod 24 with any suitable configuration when installed on the rod 24. Thus, in the embodiments illustrated in FIGS. 1A-1B, the inner surface of the inner bore and the outer surface of the rod have no extra features, or catches that retain the rod 24 within the sleeve 22 when the rod 22 is retracted from the sleeve 24. In other embodiments, a catch is disposed on either the sleeve 24 or the rod 22 or both to limit the movement of the rod 22 through at least a portion of a sleeve 24. For example, a catch disposed between the sleeve 22 and the rod 24 can limit the proximal movement of the distal end of the rod through the proximal end of the sleeve.

A catch includes one or more features or components that limit the movement of the rod 24 through the sleeve 22 beyond a certain point, a catch point. For example, the catch may limit the rod's ability to be completely withdrawn from the sleeve. Alternatively, the catch may limit the ability of the distal end of the rod to be withdrawn past a catch point of the sleeve, such as one to three inches from the proximal end of the sleeve. The catch may limit the movement of the rod 22 through this catch point, in a variety of fashions. For example, in some embodiments, the catch requires a threshold force to be applied to the rod before it permits the rod 24 to continue moving beyond the catch point. In other embodiments, the catch includes a breakable, safety component that must be broken, thus limiting the movement until the safety component is broken. In still other embodiments, the catch completely limits the rod's movement past the catch point unless the rod is oriented to a predetermined orientation in relation to the sleeve. In yet other embodiments, the catch completely limits the rods movement past the catch point. Representative embodiments of catches and catch components are depicted in FIGS. 3-8A and 10, as described below.

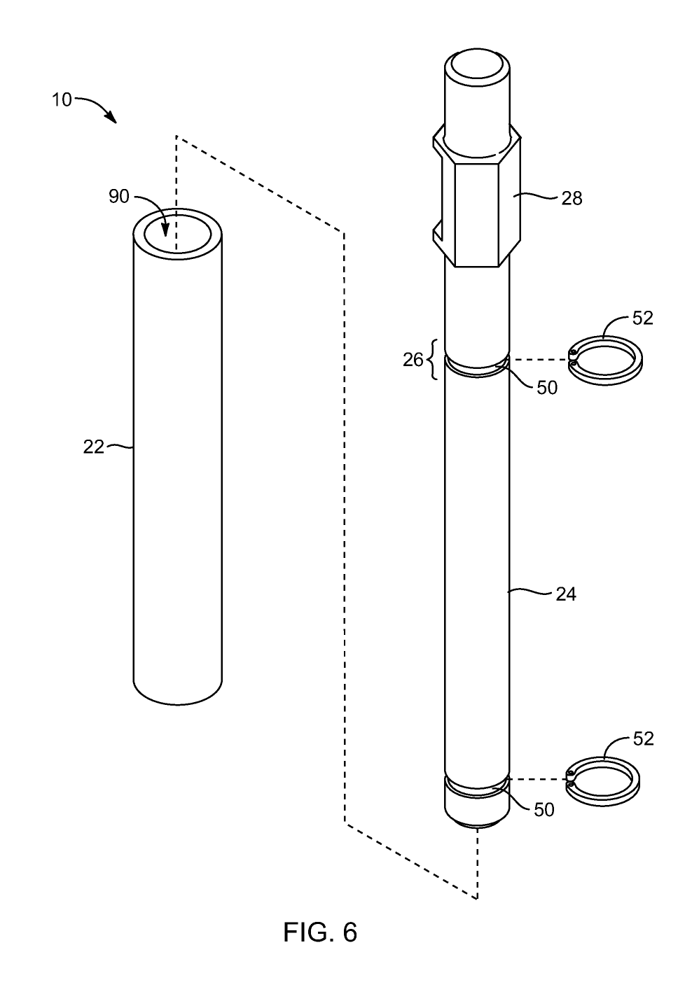

In some embodiments, the rod 24 can contain a stop 26 disposed along its length. The stop is an outward projection extending away from a portion of the body of the rod 24. The shape and size of the stop prevents that portion of the rod from entering into the sleeve 22. In some embodiments, the stop 26 is integrally formed with the rod body. For example, in some embodiments, a stop 26 is a projection that is included on the rod body when the rod is manufactured. In other embodiments, the stop 26 is a separate component, such as a circlip (or circlip ring) 52, as shown in FIG. 6 or a ring.

Since the stop 26 can prevent that portion of the rod 24 from entering the sleeve 22, in some embodiments, the distance between the distal end of the rod and the stop 26 is greater than or equal to the length of the sleeve. These distances can enable the rod 24 to extend entirely into the sleeve 22 to drive a spike 14 completely into a surface. In other embodiments, the length of the rod is equal to length of the sleeve, such that the rod extends nearly, but not exactly to the end of the sleeve, to enable the spike to be driven into a surface, but allow the head 15 of the spike 14 to remain above the surface. These distances might be useful when securing rails and tie plates to the tie. In other embodiments, an adjustable stop can be included on the rod 24. For example, multiple non-permanent stops, such as that of FIG. 6, can be included on the rod to enable a user to add, remove, or adjust the height of the stop based on the intended use.

FIG. 2 illustrates a perspective view of an installation device 10 separated from a power hammer 12. This figure also illustrates that in some embodiments the location and configuration of the power hammer connector 28 as being near the proximal end 62 of the rod 24.

FIG. 3 depicts a cross sectional view of the installation device 10 of FIG. 2. IN FIG. 3, some embodiments of two catches are shown. The distal portion 64 of the rod 24 includes a groove 50 that has been made in the rod 24. A ring 52 is inserted in the groove 50. This ring 52 surrounds the groove 50 and projects outwards from the body of the rod 24. The outwardly projecting portion of the ring 52 is one component of the both of the catches that are shown in FIG. 3.

The first catch shown in FIG. 3 limits the proximal movement of the distal end 64 of the rod through the proximal end 66 of the sleeve 22. This catch includes the groove 50 and ring 52, previously described as well as the proximal flange 40 project inwardly from the inner surface 48 of the sleeve 22. As the distal end 64 of the rod 24 is moved proximally towards the proximal end 66 of the sleeve 22, the distal surface 44 of the proximal flange 40 contacts the outwardly projecting portion of the ring 52, limiting the ring's proximal movement past the proximal flange 40 (the catch point). In some embodiments, the distal flange 40 projects inwardly a distance that is greater that the distance of the gap 60 between the ring 52 and the inner surface 48 of the sleeve 22.

The second catch shown in FIG. 3 limits the distal movement of the distal end 64 of the rod through the distal end 68 of the sleeve 22. This catch includes the groove 50, the ring 52, and the proximal flange 42. As the distal end 64 of the rod 24 is moved distally towards the distal end 68 of the sleeve 22, the proximal surface 46 of the distal flange 40 contacts the outwardly projecting portion of the ring 52, limiting the ring's distal movement past the proximal flange 40 (the catch point). This catch may be aided by a stop 26, as described herein. Likewise, in some embodiments the distal flange is omitted, permitting either the rod 24 to be removed from the distal end 68 of the sleeve 22 or permitting the stop 26 to limit the distal movement of the rod. In some embodiments, the proximal flange is omitted, permitting the rod 24 to be removed from the proximal end 66 of the sleeve 22.

As shown in FIG. 3, a gap 58 is disposed between the rod 24 and the sleeve 22 when the rod 24 is inserted into the sleeve 22. In some embodiments, this gap 58 includes a lubricant that facilitates the movement of the rod 24 within the sleeve 22. Another gap 56 is disposed between the proximal flange 40 and the rod 24. In some embodiments, a similar gap can exist between the distal flange 42 and the rod 24 when the rod 24 is positioned within the distal flange. This gap 56 permits the rod 24 to have some play while it reciprocally moves within the sleeve 22. In some embodiments, the distance of the gap 56 is greater than the distance to which the projecting portion of the ring 52 extends away from the rod 24.

The type of ring 52 used with the catches may vary the catch's ability to limit the rod's movement. For example, if a high-strength titanium ring is used, that is sized to have a very small gap 60, the catch may completely limit the rod's ability to move beyond the catch point. In other embodiments, a breakable ring may limit the rod's ability to move beyond the catch point until a sufficient force causes the breakable ring to break. In other embodiments, a flexible ring may limit the rod's ability to move beyond the catch point until a sufficient force causes the flexible ring to flex. In some embodiments, the ring 60 includes a circlip, as shown in detail in FIG. 6. The circlip can be made of a variety of materials, and have a variety of sizes, dimensions, and shapes. A circlip ring 60 may be contracted, in order for the ring 60 to be inserted into the sleeve past the distal or proximal flange 42 or 40, respectively. Once the circlip ring 60 passes the flange, it can expand slightly and thus act as a catch component.

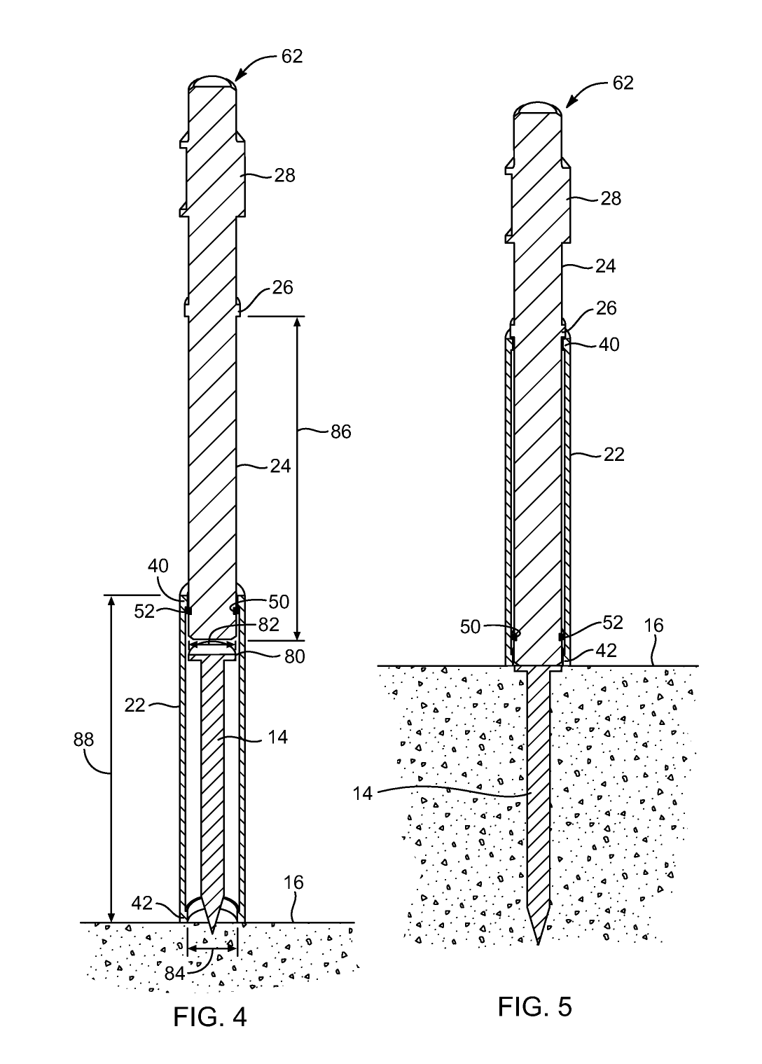

FIGS. 4 and 5 depict the use of distal and proximal flanges 42 and 40, respectively. As illustrated in FIG. 4, the proximal flange 40 limits the proximal movement of the ring 52 past distal surface of the proximal flange (the catch point of this catch). In some embodiments, this catch can prevent the rod 24 from being withdrawn from the sleeve 24 when a spike 14 is inserted into the sleeve 24 Likewise, as illustrated in FIG. 5, the distal flange 42 (along with the stop 26) limits the distal movement of the ring 52 past proximal surface of the distal flange (the catch point of this catch). In some embodiments, this catch prevents the rod 24 from driving the spike 14 too far into a surface 16.

In some embodiments, the width 84 of the opening created by the distal flange 42 is greater than or equal to the width 82 of the head 15 of a spike 14. These proportions permit the spike's head to enter and exit this opening. FIG. 4 also depicts the relative dimensions of the rod 24 and the sleeve 22. In some embodiments, as shown, the distance 86 between the stop 26 and the distal end 64 of the rod 24 is greater than or equal to the length 88 of the sleeve 22.

FIG. 6 depicts an exploded view of installation device 10. This figure illustrates that the stop 26 can include both a groove 50 and a ring 52.

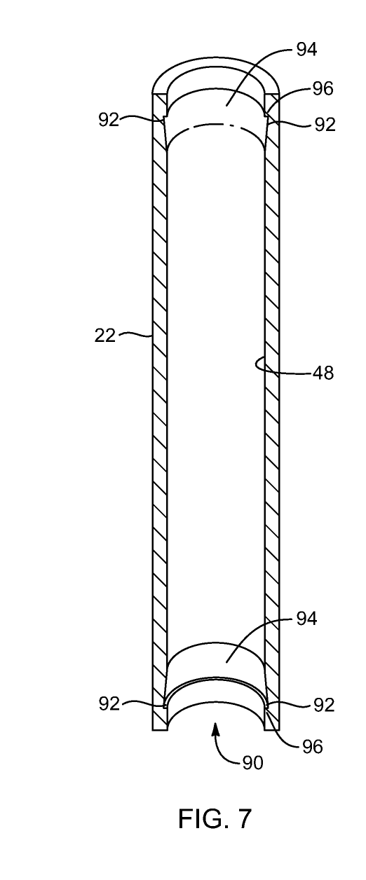

FIG. 7 depicts a cross-sectional view of the sleeve 22. This sleeve 22 is similar to the sleeve of FIG. 3 and contains similar catch components. However, rather than having two inward projecting flanges 40 and 42, the sleeve 22 of FIG. 7 includes two grooves 92 made in the inner surface 48 of the sleeve 22. In some embodiments, as shown, the sleeve 22 includes two grooves 92, a distal and a proximal bore. In other embodiments, the sleeve 22 may include only a distal or only a proximal groove. In some embodiments, the groove 92 is made around the entire inner portion of the sleeve at a certain location on the sleeve. In other embodiments, the groove 92 is only on a portion of the inner sleeve at a certain location.

In some embodiments, the groove 92 serves as a catch component along with an expandable ring 52, such as the circlip ring 52 (as shown in FIGS. 3-6). As the portion of the rod 24 having the expandable ring 52 is drawn into the groove 92, the expandable ring 52 expands. The expanded expandable ring 52 then contacts the flat wall 96 of the groove 92. The flat wall 96 limits the movement of the expanded circlip past this point, the catch point.

In some embodiments, the groove 92 includes a sloped wall 94 on the opposite side of the groove 92 as the flat wall 96. This sloped wall 94 is the wall nearest the center of the sleeve 22. After the expandable ring 52 enters the groove 92 and expands, it may be withdrawn from the groove 92 as it is drawn toward the sloped wall 94. The angle of the sloped wall allows the expandable ring 52 to contract, which permits the expandable ring 52 to be contained within the inner portions of the sleeve.

FIGS. 8A-8C illustrate a track located between the sleeve 22 and the rod 24. The tracks include one or more track guides cut into or extending from the sleeve or the rod that axially aligns the rod 24 within the sleeve 22. In some embodiments, a track prevents excess movement of the rod 22 within the sleeve 24. FIG. 8A illustrates a perspective view of a track, having a track guide, or slot, 102 cut into a distal portion of the rod 100 that mates with a track guide, or ridge, 104 that extends from the sleeve that extends along the length of the sleeve 22, as shown. Track guides may have a variety of shapes and sizes that permit the rod 24 to be aligned on the track as it moves in and out of the sleeve 22.

FIG. 8B depicts a cross sectional view of the distal portion of the rod 100, the sleeve 22, and the slot 102, and the ridge 104, taken along Line B-B of FIG. 8A. This figure illustrates the axial alignment provided by the track.

FIG. 8C illustrates a cross-sectional view of a spike head 15 within the sleeve 22 having two ridges 104. In some embodiments, the ridges 104 serves to provide stability to a spike 14 or the head 15 of a spike 14, as illustrated. Some spikes, such as railroad spikes have oval-shaped head, such as that shown in this figure. When spikes having these oval-shaped spike heads are inserted into the sleeve 22, the ridges 104 can stabilize the spikes prior to and during installation.

FIG. 9 illustrates another cross section of a sleeve 22 and a spike head 15. In the embodiments illustrated in FIG. 9, the stability provided by the circular sleeve 22 and guide track 104 of FIG. 8C can be provided without a guide track, but with an oval-shaped sleeve 22, as illustrated in FIG. 9. This sleeve can provide stability to a spike that has an oval-shaped head or body. Likewise, a square, rectangular, or other shaped sleeve can be provided to substantially match the shape of a spike or spike head.

FIG. 10 illustrates a rod 24 and sleeve 22 similar to that of FIG. 8A. Unlike FIG. 8A, the sleeve 22 includes a distal flange 42. This distal flange 42 includes a sloped proximal surface 110. In some embodiments, the sloped proximal surface 110 may facilitate the removal of spikes 14 from within the inner bore 90 by preventing the head 15 of the spike 14 from snagging on a flat proximal surface of the distal flange 42.

The installation devices described herein can reduce the potential for injury when driving a spike with a sledge hammer. Without the guide sleeve, the sledge hammer might miss hit the spike and cause the spike to fly away. A flying spike may injure the person installing the spike, as well as buildings, passing vehicles, or pedestrians. The risk of these dangers can be heightened when spikes are installing in high traffic area, such as along roadways or sidewalks. Additionally, repeatedly hefting and swinging a sledge hammer can lead to soft tissue injuries. However, the installation device described herein can reduce or avoid these risks since it permits users to quickly and accurately install spikes without the risk of soft tissue injuries or flying spikes.

In addition to any previously indicated modifications, those skilled in the art may devise numerous other variations and alternative arrangements without departing from the spirit and scope of this description. The appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

1. A device, comprising:
a sleeve having an inner bore extending therethrough, the inner bore having an inner volume shaped and sized to receive a fastener;
a rod selectively disposed within the inner bore of the sleeve, the distal end of the rod having a substantially flat surface; and
an impact device connector disposed on a proximal portion of the rod.

2. The device of claim 1, further comprising a catch disposed on the sleeve, the rod or both the sleeve and the rod, the catch limiting the proximal movement of the distal end of the rod through the proximal end of the sleeve.

3. The device of claim 2, wherein the catch includes a flange disposed on a proximal portion of the sleeve.

4. The device of claim 2, wherein the catch includes a groove disposed on a proximal portion of the sleeve.

5. The device of claim 2, wherein the catch includes a circlip coupled to the rod and a groove disposed on the inner bore.

6. The device of claim 2, wherein the catch includes an annular groove on the rod and a circlip coupled to the rod and disposed within the annular groove.

7. The device of claim 1, wherein the distal end of the rod is magnetized.

8. The device of claim 1, further comprising a catch disposed on the sleeve or the rod or both the sleeve and the rod, the catch limiting the distal movement of the distal end of the rod through the distal end of the sleeve.

9. The device of claim 1, wherein the rod comprises a stop projecting therefrom with the distance between the distal end of the rod and the stop being greater than or substantially equal to the length of the sleeve.

10. The device of claim 1, further comprising a track disposed between the sleeve and the rod with the track extending along the length of the sleeve or the rod.

11. The device of claim 10, wherein the track includes a slot and a ridge.

12. The device of claim 11, wherein the slot or the ridge is disposed on the distal end of the rod.

13. An installation device, comprising:
a sleeve having an inner bore extending therethrough, the inner bore having an inner volume shaped and sized to receive a fastener;
a rod disposed within the inner bore of the sleeve, the distal end of the rod having a substantially flat drive surface;
an impact device connector disposed on a proximal portion of the rod; and
a catch disposed on the sleeve, the rod, or both the sleeve and the rod, the catch limiting the proximal movement of the distal end of the rod through the proximal end of the sleeve.

14. The device of claim 13, wherein the rod includes a stop projecting therefrom, the distance between the distal end of the rod and the stop being greater than or equal to the length of the sleeve.

15. The device of claim 13, further comprising one or more tracks disposed between the sleeve and the rod, the one or more tracks extending along the length of the sleeve or the rod.

16. The device of claim 13, further comprising a track disposed between the sleeve and the rod with the track extending along the length of the sleeve or the rod.

17. An installation system, comprising:
an impact device; and
an installation device, comprising:
a sleeve having an inner bore extending therethrough, the inner bore having an inner volume shaped and sized to receive a fastener;
a rod disposed within the inner bore of the sleeve, the distal end of the rod having a substantially flat drive surface;
an impact device connector disposed on a proximal portion of the rod; and
a catch disposed on the sleeve, the rod, or both the sleeve and the rod, the catch limiting the proximal movement of the distal end of the rod through the proximal end of the sleeve.

18. The system of claim 17, wherein the rod comprises a stop projecting therefrom with the distance between the distal end of the rod and the stop being greater than or substantially equal to the length of the sleeve.

19. The system of claim 17, wherein the catch includes a groove disposed on a proximal portion of the sleeve, and wherein the catch further includes a protrusion disposed on the distal portion of the rod, the protrusion positioned to catch the groove.

20. The system of claim 17, further comprising a track disposed between the sleeve and the rod, the track extending along the length of the sleeve or the rod.

21. A method for driving a fastener into a solid object, the method comprising:
connecting an installation device to an impact device, the installation device having a rod selectively disposed within an inner bore of a sleeve, the inner bore of the sleeve having an inner volume shaped and sized to receive a fastener;
inserting a fastener into the inner bore of the sleeve; and
driving the fastener into a solid object via the impact force of the impact device.

22. The method of claim 21, further comprising limiting the travel of the rod within the sleeve by disposing a catch between the rod and the sleeve.

23. The method of claim 21, further comprising limiting the distal travel of the rod into the sleeve by disposing a stop on the rod.

24. The method of claim 21, further comprising axially aligning the rod within the sleeve by disposing a track between the sleeve and the rod.
